(19) United States
(12) Patent Application Publication
(10) Pub. No.: US 2008/0022995 A1
(43) Pub. Date: Jan. 31, 2008

(54) Thermal Insulation Foam For High Temperature Water Storage Applications

(75) Inventors: Zhang Ke, Shanghai (CN); Wei Lu, Shanghai (CN)

Correspondence Address: Honeywell International Inc.;Patent Services Department, 101 Columbia Road, Morristown, NJ, 07962, US

(73) Assignee: Honeywell, Inc.

(21) Appl. No.: 11/770,408

(22) Filed: Jun. 28, 2007

Related U.S. Application Data
(60) Provisional application No. 60/817,149, filed on Jun. 28, 2006.

(51) Int. Cl. F24J 2/51; C08G 18/02

(52) U.S. Cl. 126/706; 521/155

(57) ABSTRACT

There is a solar water heater system. The system has the following: a sealed storage tank, a reflective surface, and a vacuum tube. The sealed storage tank is adapted to retain water. The tank has situated at an outer surface thereof a thermal insulating layer of a closed-cell polyurethane or polyisocyanurate foam having a blowing agent therein having about 60 wt % or more of 1,1,1,3,3-pentafluoropropane therein. The reflective surface is capable of reflecting sunlight. The vacuum tube extends along the reflecting surface between the reflecting surface and the sun. The vacuum tube is in communication with the tank. There is also an outdoor insulative storage tank system.

### CROSS-REFERENCE TO A RELATED INVENTION

The present application claims priority from U.S. Provisional Application 60/817,149. The entirety of U.S. Provisional Application 60/817,149 is incorporated herein by reference.

### BACKGROUND OF THE INVENTION

1. Field of the Invention

The invention relates to rigid polyurethane or polyisocyanurate closed-cell foams prepared using 1,1,1,3,3-pentafluoropropane (HFC-245fa) as the physical blowing agent.

2. Discussion of the Background Art

The solar water heater industry has been further developed by Chinese companies. Early in the use of the heaters, low cost materials were use to insulate the outside of the water tanks of the heaters in order to reduce manufacturing cost. There were no standards regulating the thermal insulation performance, so common insulating materials were used, such as cotton fiber and plastic layers. In some instances, no insulation was used.

With the rapid growth of the solar heater market, polyurethane (PUR) and polyisocyanurate (PIR) foams blown with CFC-11 were used as thermal insulation around the water tanks. They were followed by foams blown with HCFC-141b. Some unique requirements had to be considered for the thermal insulation layer around the water tanks: (1) dimensional stability is very important due to the installed position of the water tanks—the layer of foam underneath the tanks needs to support the total weight of the “water”, which can range from 100 L to 2000 L in volume; (2) outdoor temperatures can be range from 50° C. to minus 40° C.; and (3) variation in environmental conditions from location to location. Environmental conditions include wind, rain, UV exposure, acidic corrosion, and sand storms. Given the variation in conditions, the foam layer must exhibit sufficient surface adhesion and stability.

The class of foams known as low density rigid polyurethane or polyisocyanurate foam has utility in a wide variety of insulation applications including, but not limited to, roofing systems, building panels, refrigerators and freezers. Polyurethane and polyisocyanurate foams are manufactured by reacting an organic polyisocyanate with a polyol or mixture of polyols in the presence of a volatile blowing agent or a chemical blowing agent that produces gas via chemical reaction. Volatile blowing agents are vaporized by the heat liberated during the reaction of isocyanate and polyol causing the polymerizing mixture of foam. This reaction and foaming process may be enhanced through the use of various additives such as catalysts, surfactants, compatibilizers, flame retardants, and other additives that serve to control the reaction rate of the mixture, to control and adjust cell size, to stabilize the foam structure during formation, and to optimize the physical and flammability properties of the final foam product.

The use of a fluorocarbon as the preferred blowing agent in insulating foam applications is based in part on the resulting k-factor associated with the foam produced. K-factor is a measure of the thermal conductivity of the foam and is defined as the rate of transfer of heat through one square foot of a one inch thick material in one hour where there is a difference of one degree Fahrenheit perpendicularly across the two surfaces of the material.

Fluorocarbons act not only as blowing agents by virtue of their volatility, but also are encapsulated or entrained in the closed cell structure of the rigid foam and are the major contributor to the low thermal conductivity properties of rigid urethane foams. Foams made with chlorofluorocarbon blowing agents such as trichlorofluoromethane (“CFC-11”) and hydrochlorofluorocarbons blowing agents such as 1,1-dichloro-1-fluoroethane (“HCFC-141b”) offer excellent thermal insulation, due in part to their very low vapor phase thermal conductivity, and therefore have been used widely in insulation applications.

However, the release of certain fluorocarbons, most notably chlorofluorocarbons (“CFCs”) and hydrochlorofluorocarbons (“HCFCs”), to the atmosphere is now recognized as contributing to the depletion of the stratospheric ozone layer. In view of the environmental concerns with respect to CFCs and HCFCs, the use of CFC-11 has been phased out and HCFC-141b is in the process of being phased out and replaced by the zero ozone depletion potential materials such as hydrofluorocarbons (“HFCs”), hydrocarbons, CO₂ produced by the reaction of water with isocyanate, and other materials.

It would be desirable to use zero ozone depletion potential blowing agents, such as water, hydrocarbons and hydrofluorocarbons. However, water is not an optimal blowing agent by itself because foams produced lacks the same degree of thermal insulation efficiency, dimensional stability and adhesion as foam made with CFC or HCFC blowing agents. Hydrocarbon blowing agents may be flammable, and, therefore, are less desirable. Because rigid polyurethane foams must comply with building codes or other regulations, such foams expanded with a hydrocarbon blowing agent may require the addition of relatively high levels of expensive flame retardant materials. Also, hydrocarbon blowing agents may be classified as volatile organic compounds (VOC) and be subject to environmental regulation.

Hydrofluorocarbons, especially 1,1,1,3,3-pentafluoropropane (HFC-245fa), offer many of the advantages of the CFC and HCFC blowing agents, including non-flammability, low vapor phase thermal conductivity, safety, and ease of use. Further, because of the absence of chlorine on the molecule, it does not contribute to the depletion of the Earth's ozone layer.

Currently, the most frequently used blowing agents in insulation layers in solar heater devices (e.g., solar heater water tanks) are environmentally undesirable CFCs, such as CFC-11, which are know to damage the stratospheric ozone layer.

Continuous and strong economic development through better utilization limited nature resources, product innovation on energy saving, clean environmental control (clean air, water) will become increasingly important in Asia, especially in China. One area of fast growth identified to be significantly developed will be new technology and product innovation relating to the use of “green” energy, such as solar energy. One such particular product is a “solar heater” device that converts solar energy during the heating-up of ambient temperature water. The heated water is then used for either an industrial process (for example, a medicine extraction or wet-to-dry pipe process) or residential home application (for example, shower water or for warming a house).

A better thermal insulation solution (i.e., foam layer) for the water tank in the solar heater device is very important since the inside temperature of water can easily reach 40° C. to 100° C. while the external environmental temperature are much lower (can be minus 40° C. for northern-hemisphere regions and minus 1° C. to 10° C. in southern-hemisphere regions during winter time). All residential water heater systems powered with electricity also require the same thermal insulation foam layer for their respective water storage tanks to reduce energy consumption. The same requirements also apply for all the small-to-medium size water treatment systems (some of the units are integrated with carbon, or silicon oxide filters, O₃ system), in which both cold and hot water can be produced by semiconductor refrigeration or electricity heating elements. A better thermal insulation for this type of build-in water tank is very critical in achieving low electricity consumption. A better thermal insulation will become more important under a condition of high temperature (a typical range will be 90° C. to 99° C.). Therefore, new technology and product innovation are needed to meet both energy efficiency and environmental control standards.

Currently, both conventional thermal insulation materials, e.g., rubber-based structures and nature plant fibers, and PUR foams manufactured with physical blowing agents, e.g., CFC-11 and HCFC-141b, have been used in water tank thermal insulation. Problems encountered with these materials include poor thermal insulation performance (K factor) and poor dimensional stability at high temperatures (40° C. to 100° C.).

### SUMMARY OF THE INVENTION

According to the present invention, there is provided a solar water heater system. The system has the following: a sealed storage tank, a reflective surface, and a vacuum tube. The sealed storage tank is adapted to retain water. The tank has situated at an outer surface thereof a thermal insulating layer of a closed-cell polyurethane or polyisocyanurate foam having a blowing agent therein having about 60 wt % or more of 1,1,1,3,3-pentafluoropropane. The reflective surface is capable of reflecting and optionally focusing sunlight. The vacuum tube extends along the reflecting surface between the reflecting surface and the sun. The vacuum tube is in communication with the tank.

According to the present invention, there is further provided a solar water heater system as described above except that the blowing agent therein has about 60 wt % or more of a hydrofluorocarbon.

Further according to the present invention, there is provided an outdoor insulative storage tank system. The system has a tank that is situated outdoors and is adapted to retain a liquid. The outer surface of the tank is partially or entirely covered with a thermal insulating layer of a closed-cell polyurethane or polyisocyanurate foam having a blowing agent therein having about 60 wt % or more of 1,1,1,3,3-pentafluoropropane therein.

According to the present invention, there is further provided a tank system as described above except that the blowing agent therein has about 60 wt % or more of a hydrofluorocarbon.

### BRIEF DESCRIPTION OF THE DRAWINGS

FIG. 1 is a schematic representation of a vacuum tube and tank being exposed to sunlight for generation of solar energy and its conversion to heat; and

FIG. 2 is a perspective, cutaway view of solar water heater system according to the present invention.

### DETAILED DESCRIPTION OF THE PREFERRED EMBODIMENT

The foam according to the present invention has unexpectedly performed much better under high temperatures. The foam has a uniform cell structure and low gas diffusion rate among the polymer metrics (matrix).

PU and PUR foams blown with HFC-245fa provide additional advantages when used in solar heater devices compared to foams blown with other blowing agents, such as HCFC-141b and cyclopentane. Such advantages include the following: (a) low conversion cost in term of equipment and processing in both the manufacture of the blowing agent and the manufacture and operation of the solar heating device, (b) safety for operating and non-flammable agent, (c) lower foam density (can be 10% lower than foams blown with HCFC-141b and cyclopentane systems, (d) potential reduction in overall cost through formulation optimization, (e) good insulation performance at low and freezing temperatures, and (f) good dimensional stability at low and freezing temperatures.

Based on the experimental data of HFC-245fa used as blowing agent for the closed-cell foam layer on solar heaters, far better thermal insulation properties were observed at different weather conditions than for foams blown with conventional blowing agents. Another advantage was a cost reduction due to the reduction in the use of metal materials as a cover layer of the PUR/PIR layer, as is the case for most PUR/PIR foams. The enhanced insulation properties of the HFC-245fa blowing agent afforded a substantial reduction in the thickness requirement of the layer in a range of between about 5 mm to 15 mm, thereby significantly reducing the raw material cost to build a solar heater. Another important advantage is that the HFC-245fa-based PUR/PIR foam is that it exhibited far better mechanical strength than conventional foams, such as those blown with HCFC-141b. Although not bound by any particular theory, the more uniform and smaller-diameter “foam cell” within the HFC-245fa based PUR/PIR foam, layer i.e., smaller average cell size, contributed these performance enhancements over conventional foams.

Lastly, the foam formation on the solar water tank is totally different with the case of typical appliance (refrigerator/freezer) application where relatively high molding pressures have to be applied to form the PU foam to create a dimensionally stable product, so the density requirement on the PU foam of a solar heater is different. For this reason, new formulation technology had to be developed for this application. Unlike appliance foams where the foams are “overpacked” in the mold by 10-20% to increase density and improve dimensional stability, the foam of this invention does not need to be packed. The manufacturing process for splar water heaters is not conducive to this packing so this is a critical requirement of the foaming system.

The present inventors developed a unique polyol and MDI formulation that demonstrated very good physical adhesion to metal surfaces, e.g. steel, coated steel, and aluminum. The strength of adhesion will is measured to meet specifications. Despite a much smaller average cell size, the HFC-245fa-blown PUR foam of the present invention unexpectedly provided very good adhesion properties with metal surfaces.

The blowing agent preferably has about 60 wt % or more, more preferably about 90 wt % or more, and most preferably about 95 wt % or more of 1,1,1,3,3-pentafluoropropane (HFC-245fa) based on the total weight of the blowing agent. The blowing agent may have other organic and inorganic co-blowing agents, such water, carbon dioxide, hydrocarbons, hydrofluorocarbons, and hydrochlorofluorocarbons. Hydrofluorocarbons are preferred co-blowing agents. Examples of useful hydrofluorocarbons (other than HFC-245fa) include, but are not limited to, the following: pentafluoropropane isomers (HFC-245) other that HFC-245fa, difluoromethane (HFC-32), difluoroethane isomers (HFC-152), trifluoroethane (HFC-143), tetrafluoroethane isomers (HFC-134), pentafluoroethane isomers (HFC-125), hexafluoropropane isomers (HFC-236), heptafluoropropane isomers (HFC-227), pentafluorobutane isomers (HFC-365), fluoroethane isomers (HFC-161), difluoropropane isomers (HFC-272), trifluoropropane isomers (HFC-263), tetrafluoropropane isomers (HFC-254), fluoropropane isomers (HFC-281), hexafluorobutane isomers (HFC-356), decafluoropentane isomers (HFC-43-10mee), perfluoroethane, perfluoropropane, perfluorobutane, perfluorocyclobutane, and difluoropropane. Isomers may be presently either singly or in the form of a mixture.

In a broader aspect of the invention, the foam can be blown with any or a combination of two or more of the aforementioned hydrofluorocarbons, with or without HFC-245fa. The blowing agent preferably has about 60 wt % or more, more preferably about 90 wt % or more, and most preferably about 95 wt % or more of a fluorocarbon based on the total weight of the blowing agent. The blowing agent may have other organic and inorganic co-blowing agents, such water, carbon dioxide, hydrocarbons, hydrofluorocarbons, and hydrochlorofluorocarbons.

HFC-245fa, the preferred blowing agent, can be prepared by methods known in the art, such as those disclosed in WO 94/14736, WO 94/29251, WO 94/29252 and U.S. Pat. No. 5,574,192, all of which are incorporated herein by their entirety.

These ingredients may be added individually to the reaction mixture by suitable metering equipment or methods or by introduction of preblended components. The first component comprises the isocyanate and optionally a surfactant and/or blowing agent, and a second component, which comprises the polyol or polyol mixture and the blowing agent plus other additional additives selected from the group consisting of: catalysts, surfactants, dispersing agents, compatibilizers, cell stabilizers, nucleating agents, flame retardants, additional polyols, colorants, and other materials commonly used in the production of polyurethane or polyisocyanurate foams. Alternatively, a third component may be added to the first and second components, wherein the third component comprises at least one additional additive selected from the group consisting of: catalysts, surfactants, auxiliary blowing agents, dispersing agents, compatibilizers, cell stabilizers, flame retardants, additional polyols, colorants and other materials normally used in the production of polyurethane or polyisocyanurate foams.

The blowing agent is used within the range of from between about 1 to about 60 parts by weight of blowing agent per 100 parts by weight of polyol. Preferably, an amount from between about 5 to about 40 parts by weight of blowing agent per 100 parts by weight of polyol is used.

In the process for making the foam, the blowing agent has about 1 to about 60, preferably about 5 to about 40, more preferably about 10 to about 20, still more preferably about 13 to about 18, and most preferably about 14 to about 16 weight parts of blowing agent per 100 weight parts of the polyol. The blowing agent may optionally have up to about 3 weight parts of water per 100 weight parts of the polyol. In a particular embodiment, the blowing agent has about 15 to about 20 weight parts of a hydrofluorocarbon and about 1 to about 3 or about 1 to about 2 weight parts of water per 100 weight parts of the polyol.

Foams made with blowing agents of hydrofluorocarbon, such as HFC-245fa, have been found to possess low initial and aged thermal conductivity and good dimensional stability, especially at low temperatures. The foams are closed cell. A closed cell foam is about 90% or more and preferably 95% for more closed cell.

The resultant closed-cell structure contains HFC-245fa and demonstrates better thermal insulation properties when used in a solar water heater or other water storage application covering a range of 40° C. to 90° C. (or even to 100° C.) compared to other foams blown using CFC-11 or HCFC-141b.

The polyurethane and polyisocyanurate foams may be manufactured according to any of the methods well known in the art, such as those described in “Polyurethanes Chemistry and Technology,” Volumes I and II, Saunders and Frisch, 1962, John Wiley and Sons, New York, N.Y. In general, the method comprises preparing polyurethane or polyisocyanurate foams by combining an isocyanate, a polyol or mixture of polyols, a blowing agent or mixture of blowing agents, and other materials, such as catalysts, nucleating agents, surfactants, and, optionally, flame retardants, colorants, or other additives.

It is convenient in many applications to provide the components for polyurethane or polyisocyanurate foams in preblended formulations. Most typically, the foam formulation is preblended into two components. The isocyanate and, optionally, certain surfactants and blowing agents make up the first component, commonly referred to as the “A” or “iso” component. The polyol or polyol mixture, surfactant, catalysts, blowing agents, flame retardant, and other isocyanate reactive components make up the second component, commonly referred to as the “B”, or “polyol” or “resin” component. Accordingly, polyurethane or polyisocyanurate foams are readily prepared by bringing together the A and B components either by hand-mixing for small preparations and, preferably, machine-mixing techniques to form blocks, slabs, laminates, pour-in-place panels and other items, spray applied foams, froths, and the like. Optionally, other ingredients, such as colorants, auxiliary blowing agents, and even other polyols can be added as a third stream to the mix head or reaction site. Most conveniently, however, they are all incorporated into one B component as described above.

Dispersing agents, cell stabilizers, and surfactants may also be incorporated into the blowing agent mixture. Surfactants are added to serve as cell stabilizers. Some representative materials are sold under the names of DC-193 (Dow Corning), B-8404 (made by Degussa), and L-5340 (Monentive) that are, generally, polysiloxane polyoxyalkylene block co-polymers such as those disclosed in U.S. Pat. Nos. 2,834,748, 2,917,480, and 2,846,458, all of which are incorporated herein by reference in their entirety. Other optional additives for the blowing agent mixture may include flame retardants such as tris (2-chloroethyl) phosphate, tris (2-chloropropyl) phosphate, tris (2,3-dibromopropyl)-phosphate, tris (1,3-dichloropropyl) phosphate, various halogenated aromatic compounds, and the like.

Generally speaking, the amount of blowing agent present in the blended mixture is dictated by the desired foam densities of the final polyurethane or polyisocyanurate foam product. The polyurethane foam produced can vary in density from about 0.5 pound per cubic foot to about 40 pounds per cubic foot, preferably from about 1.0 to about 20.0 pounds per cubic foot, and most preferably from about 1.5 to about 6.0 pounds per cubic foot for rigid polyurethane foams. The density obtained is a function of several factors, including amount of blowing agent present in the A and/or B component and amount, if any, added at the time the foam is prepared.

Any organic isocyanate can be employed in polyurethane or isocyanurate foam synthesis inclusive of aliphatic and aromatic isocyanates. Preferred, as a class, are the aromatic isocyanates. Preferred isocyanates for rigid polyurethane or polyisocyanurate foam synthesis are the methylene phenyl isocyanates, particularly the mixtures containing from about 30 to about 85 percent by weight of methylenebis (phenyl isocyanate) with the remainder of the mixture being methylene phenyl isocyanates of functionality higher than 2.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray-applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Examples of polyols used in polyurethane-modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose-based polyols used in refrigerator/freezer foam, applications or Mannich base polyols used in spray foam applications.

Catalysts used in the manufacture of polyurethane foams are typically tertiary amines including, but not limited to, N-alkylmorpholines, N-alkylalkanolamines, N,N-dialkylcyclohexylamines, and alkylamines in which the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl) ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts can be used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic methyl formates such as stannous octoate, stannous 2-ethylhexoate, stannous laurate, and the like, as well as dialkyl tin salts of carboxylic methyl formates such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic methyl formate salts, and mixtures thereof. Preferred species within the classes are potassium acetate, potassium octoate, and N-(2-hydroxy-5-nonylphenol) methyl-N-methylglycinate.

The components of the composition of the invention are known materials that are commercially available or may be prepared by known methods. Preferably, the components are of sufficiently high purity so as to avoid the introduction of adverse influences on blowing agent properties of the system.

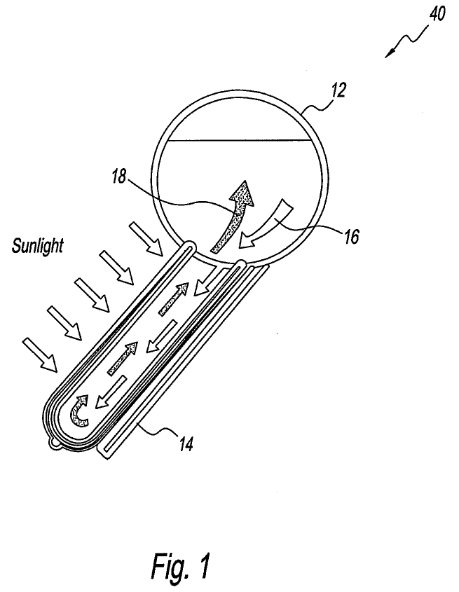

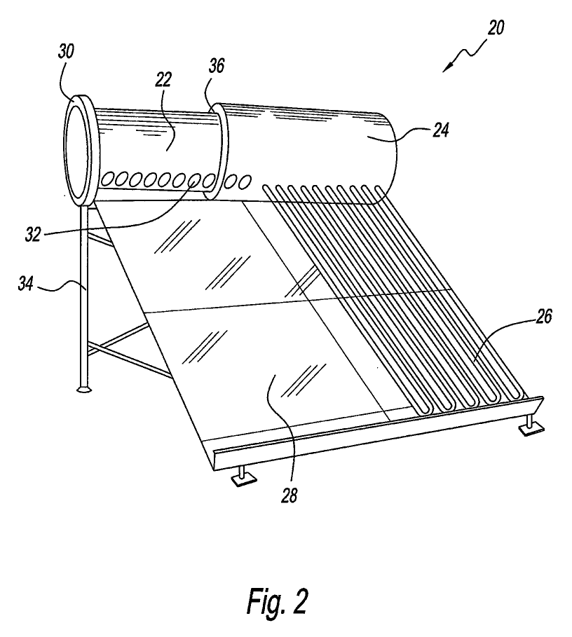

Embodiments of the present invention are shown in FIGS. 1 and 2.

A schematic representation the phenomena of a conversion cycle of sunlight and solar energy to heat is shown in FIG. 1 and is generally represented by the numeral 10. Conversion cycle 10 has a tank 12 and a vacuum tube 14. Tank 12 and vacuum tube 14 have water therein, which is represented generally by temperature as cold water 16 and hot water 18. Vacuum tube 14 is exposed to sunlight and cold water 16 therein is heated up to form hot water 18. Hot water 18 flows into and upward in tank 12 due to density difference between hot water 18 and cold water 16. Cold water 16 in tank 12 flows downward into vacuum tube 14 due to the density difference, wherein it is reheated and the cycle is repeated. The water level in tank 12 is represented by the numeral 17.

An embodiment of the solar heating system of the present invention is shown in FIG. 2 and is generally represented by the numeral 20. System 20 has an inner water tank 22, an outer water tank 24, a vacuum glass tube 26, a reflector 28, a water tank lid 30, seal rings 32, a stand 34, and an insulation layer 36. Insulation layer 36 is situated between inner tank 22 and outer tank 24 and extends along the entire length of the outer surface of inner water tank 22. Outer tank 24 also extends along the entire length of the outer surface of inner water tank 22. Insulation layer 36 is preferably injected between inner tank 22 and outer tank 24 in the form of a PUR/PIR foam blown with hydrofluorocarbons (foam-in-place). FIG. 2 shows a cutaway view of the inner tank 22, outer tank 24, and insulation layer 36 so that their relative positioning is manifest. Although not critical to the invention, the thickness of insulation layer 36 may typically range from about 50 mm to about 60 mm.

Water flows in a cycle between inner tank 22 and vacuum glass tube 26 via density variation between hot and cold water as described above for the conversion cycle in FIG. 1. Vacuum tube 26 takes a continuous U-shaped configuration along the entire length of reflector 28 (not shown). FIG. 2 shows the extension of vacuum tube 26 across reflector 28 in cutaway so as to show a view of a portion of reflector 28 without obstruction.

The conversion cycle ensures that hot water is always present in inner water tank 22. As desired, hot water can be withdrawn from inner tank 22 for use by a consumer (not shown). Although vacuum tube 26 is preferably constructed of glass, metals such as aluminum may be substituted, if desired. Inner and outer tanks 22 and 24 may be constructed of glass, plastic, or a metal such as steel or aluminum. Metal is a preferred material for inner and outer tanks 22 and 24. Stand 34 is a mechanical apparatus for bracing and holding upright the other portions of system 20. Tank lid 30 provides access to the inside on inner tank 22. Seal rings 32 provide water-tight seals between the plurality of interfaces between vacuum tube 26 and inner tank 22.

The following are non-limiting examples of the present invention. Unless otherwise indicated, all percentage or parts are by weight.

### EXAMPLES

Six sets of solar heater systems each with a thermal insulation layer manufactured with HFC-245fa and CFC-11 were tested at in accordance with testing procedures based on either China or international standard: GB/T-18708-2002 and ISO 9459. The heater systems with thermal insulation layers manufactured with HFC-245fa were the examples of the invention. The heater systems with thermal insulation layers manufactured with CFC-11 were the comparative examples. Results are set forth below in Tables 1 and 2.

TABLE 1
(Measurement of Thermal Insulation
Property on Water Storage Tank)

| | | foaming | Thermal | |
|---|---|---|---|---|
| | blowing | thickness | insulation | |
| Sample | agent | (mm) | (W/(m³ · K) | Average |
| 1 2005TR039 | 245fa | 45 | 10.4 | 12 |
| 2 2005TR040 | 245fa | 45 | 13.6 | |
| 3 2005TR041 | 245fa | 50 | 11.8 | 11.5 |
| 4 2005TR042 | 245fa | 50 | 11.2 | |
| 5 2005TR043 | CFC-11 | 60 | 13.6 | 14.25 |
| 6 2005TR044 | CFC-11 | 60 | 14.9 | |

TABLE 2

| | Heat Capacity/Daily | Storage T | Heat Loss |
|---|---|---|---|
| Sample | MJ/m² | ° C./s | W/m³ · K |
| 1 | 8.5 | 44 | 15 |
| 2 | 8.2 | 44 | 17 |
| 3 | 8.5 | 49 | 13 |
| 4 | 8.2 | 49 | 13 |
| 5* | 8.5 | 50 | 20 |
| 6* | 8.8 | 50 | 21 |

*Samples blown with CFC-11 are not examples of the present invention

Based on the data shown as above in Tables 1 and 2, the foam layer made from the HFC-245fa-based systems demonstrated much better thermal insulation properties than the foam system by using CFC-11. In addition, it was determined that the same thermal insulation effect can be achieved by used a much thinner HFC-HFC-245fa based insulation foam. Currently, a typical thickness of a thermal insulation layer for a water tank is about 60 mm and the product specification for thermal insulation had been set as below 20 (W/m³.K) according to the National Standard. Therefore, a much thinner foam layer (50 mm or even 45 mm) can be designed and adopted with a better thermal insulation performance (less than 12 W/m³.K). The thickness reduction is almost equal to 16% to 25% as compared with the conventional production standard (60 mm). In additional, it had been noted that the measurement actually had been performed under a real outdoor temperature of around 4° C., well below the 8° C. that has been specified in the standard testing procedures, thereby demonstrating that the thermal insulation properties of HFC-245fa-based system according to the present invention exhibited far greater thermal insulation properties than conventional foams.

The HFC-245fa-based system performs well under high temperature in the case of solar heater application both in dimension stability and thermal insulation. The data (see Tables 1 and 2) indicated that a much thinner foam layer (50 mm vs. 60 mm, or 45 mm vs. 60 mm) with a thickness reduction in the range of 16%-25% can be designed and implemented having enhanced thermal insulation properties. The thickness reduction will provide more options to design a solar heater device exhibiting better energy saving, yet with a material cost reduction. On the other hand, since the HFC-245fa-based system has ODP-free (Ozone Depletion Potential) blowing foam as compared with CFC or HCFC-type blowing agent, its application will provide significant environmental benefits as well.

What is claimed is:

1. A solar water heater system, comprising:
a) a sealed storage tank adapted to retain water, the tank having situated at an outer surface thereof a thermal insulating layer of a closed-cell polyurethane or polyisocyanurate foam having a blowing agent therein having about 60 wt % or more of 1,1,1,3,3-pentafluoropropane therein;
b) a surface capable of reflecting sunlight; and
c) a vacuum tube extending along the reflecting surface between the reflecting surface and the sun, the vacuum tube being in communication with the tank.

2. The heater system of claim 1, wherein the blowing agent includes a blowing agent therein having about 90 wt % or more of 1,1,1,3,3-pentafluoropropane therein.

3. The heater system of claim 1, wherein the blowing agent includes a blowing agent therein having about 95 wt % or more of 1,1,1,3,3-pentafluoropropane therein.

4. The heater system of claim 1, wherein the reflective surface is a metallized surface or mirror.

5. The heater system of claim 1, wherein the tank is constructed of a metal or a glass.

6. An outdoor insulative storage tank system, comprising an tank adapted to retain a liquid, the outer surface of the tank being partially or entirely covered with a thermal insulating layer of a closed-cell polyurethane or polyisocyanurate foam having a blowing agent therein having about 60 wt % or more of a hydrofluorocarbon therein, the tank being situated outdoors.

7. The tank system of claim 6, wherein the blowing agent has about 60 wt % or more of 1,1,1,3,3-pentafluoropropane therein.

8. The tank system of claim 6, wherein the hydrofluorocarbon is selected from the group consisting of a pentafluoropropane isomer(s), difluoromethane, difluoroethane isomer(s), trifluoroethane, tetrafluoroethane isomers, pentafluoroethane isomer(s), hexafluoropropane isomer(s), heptafluoropropane isomer(s), pentafluorobutane isomer(s), fluoroethane isomer(s), difluoropropane isomer(s), trifluoropropane isomer(s), tetrafluoropropane isomer(s), fluoropropane isomer(s), hexafluorobutane isomer(s), decafluoropentane isomer(s), perfluoroethane, perfluoropropane, perfluorobutane, perfluorocyclobutane, and difluoropropane.

9. A solar water heater system, comprising:
a) a sealed storage tank adapted to retain water, the tank having situated at an outer surface thereof a thermal insulating layer of a closed-cell polyurethane or polyisocyanurate foam having a blowing agent therein having about 60 wt % or more of a hydrofluorocarbon therein;
b) a surface capable of reflecting sunlight; and
c) a vacuum tube extending along the reflecting surface between the reflecting surface and the sun, the vacuum tube being in communication with the tank.

10. The heater system of claim 9, wherein the hydrofluorocarbon is selected from the group consisting of a pentafluoropropane isomer(s), difluoromethane, difluoroethane isomer(s), trifluoroethane, tetrafluoroethane isomers, pentafluoroethane isomer(s), hexafluoropropane isomer(s), heptafluoropropane isomer(s), pentafluorobutane isomer(s), fluoroethane isomer(s), difluoropropane isomer(s), trifluoropropane isomer(s), tetrafluoropropane isomer(s), fluoropropane isomer(s), hexafluorobutane isomer(s), decafluoropentane isomer(s), perfluoroethane, perfluoropropane, perfluorobutane, perfluorocyclobutane, and difluoropropane.
